(19) United States
(12) Patent Application Publication
(10) Pub. No.: US 2012/0270200 A1
(43) Pub. Date: Oct. 25, 2012

(54) Electronic Flash Card Device and Method of Use Thereof for Passive Learning

(76) Inventor: Donald Richard STEARNS, Santa Monica, CA (US)

(21) Appl. No.: 13/415,485

(22) Filed: Mar. 8, 2012

Related U.S. Application Data
(60) Provisional application No. 61/450,465, filed on Mar. 8, 2011.

(51) Int. Cl. G09B 5/00

(52) U.S. Cl. 434/322

(57) ABSTRACT

The electronic flash card device is an apparatus that allows a user to complete a learning objective without a conscious effort. A plurality of such apparatuses is positioned throughout the areas that the user occupies daily. The user then passively views, remembers, and learns a plurality of teaching points that are displayed on the apparatus. Each teaching point has an initial portion, which is shown first, and has associated portion, which is shown second along with the initial portion. For example, if the user knows English and wants to learn Spanish, then the initial portion would be a word in English and the associated portion would be the same word in Spanish. The apparatus can also be used to learn simple arithmetic by first showing the arithmetic problem and then showing the arithmetic problem with its answer. The apparatus continuously displays the plurality of teaching points in a timed sequence.

The current application claims a priority to the U.S. Provisional Patent application Ser. No. 61/450,465 filed on Mar. 8, 2011.

### FIELD OF THE INVENTION

The present invention relates generally to a method for learning. More particularly, the present invention is a repetitive informational delivery system with sequential alterable timing.

### BACKGROUND OF THE INVENTION

Current methods, devices or systems are only applicable to individuals who have the equipment and or time to devote to the learning process. There has not been sufficient attention paid to accomplish bi-lingualism with regard to Spanish and English speaking American citizens and non-citizens. The same analogous failure of United States' conversion to the metric system began in the 1950s, and to this day, America's society still thinks in terms of inches, feet, and pounds. About two years ago, a $400 million satellite was lost due to an error of conversion from pounds per square inch to metric weight and measure. We have ignored the promise, responsibility, and necessity to conform to the global standard, and consequently, we are suffering dearly in the education and the field of science. The display of information as described earlier could be focused on metric equivalency with more ease than language although eventually, both Spanish and English will embody metric translations. It is therefore an object of the present invention to introduce a passive learning system through a plurality of electronic flash card devices, which the societal solution without the need for altering an individual's behavior.

### BRIEF DESCRIPTION OF THE DRAWINGS

FIG. 1 is a schematic diagram of the components of the present invention.

FIG. 2 is a flow chart depicting the computer executable process that is followed by the present invention.

FIG. 3 is a flow chart depicting the method of using the present invention.

FIG. 4 is the present invention flashing the initial portion of an English-to-Spanish exercise during the first time period in order to teach the word “house”.

FIG. 5 is the present invention flashing both the initial portion and the associated portion of the English-to-Spanish exercise during the second time period in order to teach the word “house”.

FIG. 6 is the present invention flashing the initial portion of an English-to-Spanish exercise during the first time period in order to teach the word “where”.

FIG. 7 is the present invention flashing both the initial portion and the associated portion of the English-to-Spanish exercise during the second time period in order to teach the word “where”.

FIG. 8 is the present invention flashing the initial portion of an arithmetic exercise during the first time period in order to teach addition.

FIG. 9 is the present invention flashing both the initial portion and the associated portion of the arithmetic exercise during the second time period in order to teach addition.

FIG. 10 is the present invention flashing the initial portion of an arithmetic exercise during the first time period in order to teach addition.

FIG. 11 is the present invention flashing both the initial portion and the associated portion of the arithmetic exercise during the second time period in order to teach addition.

### DETAIL DESCRIPTIONS OF THE INVENTION

All illustrations of the drawings are for the purpose of describing selected versions of the present invention and are not intended to limit the scope of the present invention.

The present invention is an electronic flash card device, which allows a user to passively complete a learning objective such as learning another language or learning simple arithmetic. A plurality of the electronic flash card devices is placed around the user's daily living area and/or their work place so that the user can passively view the electronic flash card devices throughout their day. The present invention can be placed anywhere that the user spends a significant portion of their day, which may include a play place, a restaurant, a school, or armed forces facilities. The present invention continuously displays a plurality of teaching points that are related to the learning objective. Each teaching point has an initial portion and an associated portion. The present invention first flashes the initial portion and then flashes both the initial portion with the associated portion as a means to teach the learning objective. For example, if the user knew English and wanted to learn Spanish, the present invention would first display a word in English as the initial portion. Then, the present invention would simultaneously display the initial portion and the word in Spanish as the associated portion. Similar to a clock, the present invention will continuous display the plurality of teaching points in a timed sequence for twenty four hours a day, seven days a week.

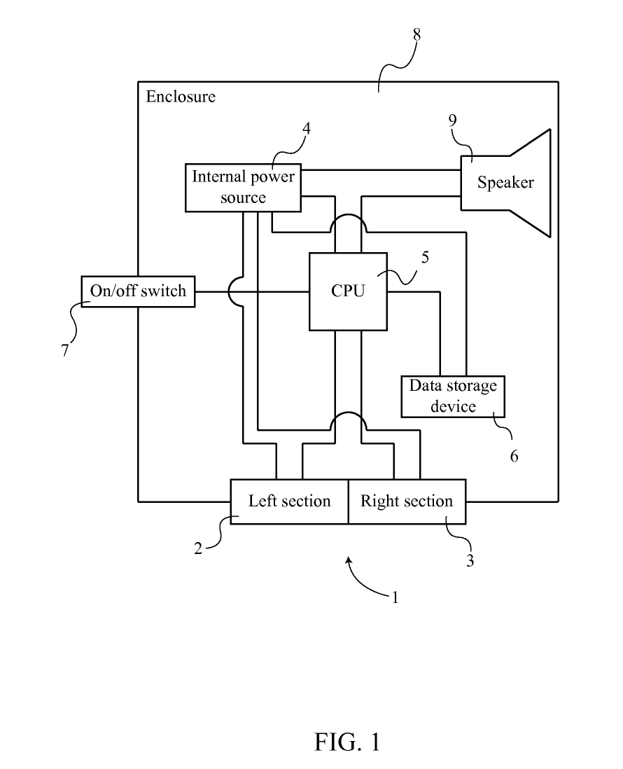

The present invention is a small, lightweight apparatus that can be easily placed within the daily living area or the work place without being obtrusive. As can be seen in FIG. 1, the present invention mainly comprises a display panel 1, an internal power source 4, a central processing unit (CPU) 5, a data storage device 6, an on/off switch 7, an enclosure 8, and a speaker 9. The enclosure 8 is a protective casing that prevents damage to the internal components of the present invention. The internal power source 4, the CPU 5, the data storage device 6, and the speaker 9 are located inside of the enclosure 8. The display panel 1 is framed onto the enclosure 8 so that the enclosure 8 does not obstruct the view of the display panel 1 from the user. The display panel 1 is an electronic viewing device that can be used to show letters or numbers. In the preferred embodiment of the present invention, the display panel 1 is more specifically a light emitting diode (LED) display panel. The display panel 1 is divided into a left section 2 and a right section 3, which are used to simultaneously show two different images. In the preferred embodiment, the left section 2 is used to view the initial portion of a teaching point and the right section 3 is used to view the associated portion of a teaching point because text is read from left to right in Western culture. In Arabic culture, text is read from right to left, and, in an Arabic embodiment of the present invention, the right section 3 would be used to view the initial portion and the left section 2 would be used to view the associated portion. The left section 2 has a separate electronic connection to the CPU 5 than right section 3 so that the CPU 5 is able to send two separate images to the left section 2 and the right section 3.

The CPU 5 manages all of the other electronic components for the present invention and the flow of data from one electronic component to another electronic component. Thus, the CPU 5 is also electronically connected to the data storage device 6, the on/off switch 7, and the speaker 9. The data storage device 6 contains the plurality of teaching points in a digital data format that can be interpreted by the CPU 5. The on/off switch 7 allows the user to activate or deactivate the present invention. The on/off switch 7 is also positioned on the enclosure 8 so that the user can easily access the on/off switch 7. The speaker 9 allows the present invention to speak the associated portion of the teaching point if the associated portion uses a different alphabet than the user's natural language. For example, if the present invention is used to teach an English-to-Chinese learning objective, then the initial portion will be shown in English on the left section 2 and the associated portion will be spoken aloud in Chinese by the speaker 9. The speaker 9 is also positioned adjacent to enclosure 8 so that the user is better able to hear to the speaker 9 through the enclosure 8. Finally, the internal power source 4 is used to power all the electronic components for the present invention, and, thus, the internal power source 4 is electrically connected to the left section 2, the right section 3, the CPU 5, the data storage device 6, and the speaker 9. The internal power source 4 allows the present invention to be portable so that the present invention can be placed anywhere in the user's daily living area or their workplace. In the preferred embodiment of the present invention, the internal power source 4 is a battery, but the present invention could use a solar power source, similar to a portable solar-powered calculator.

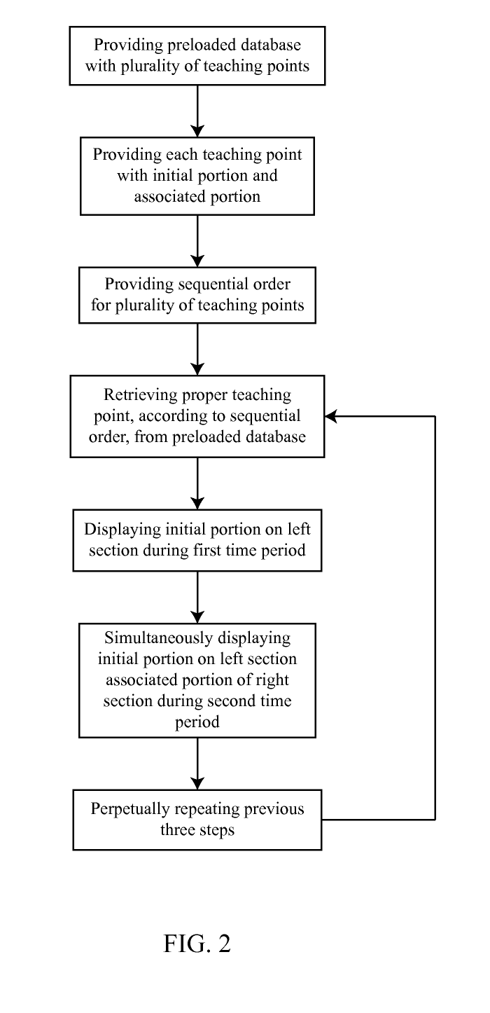

As can be seen in FIG. 2, the present invention follows a computer executable process so that the user can accomplish their learning objective. Before beginning the process, the present invention already has access to preloaded database, which is stored on the data storage device 6. The preloaded database is customized to the user's learning objective such as learning a different language or learning simple arithmetic. The preloaded database contains the plurality of teaching points that are related to the learning objective. The preloaded database also contains the sequential order that the plurality of teaching points should be displayed in by the present invention. The first step of the process is to retrieve a proper teaching point from the preloaded database. The proper teaching point is the teaching point that is supposed to be shown on the display panel 1, according to the sequential order of the plurality of teaching points. In the preferred embodiment, the second step is to display the initial portion of the proper teaching point on the left section 2 of the display panel 1 during a first time period. During the first time period, the right section 3 of the display panel 1 is left blank. The first time period should be two seconds, but the first time period could be a different length of time. Also in the preferred embodiment, the third step is to simultaneously display both the initial portion on the left section 2 and the associated portion on the right section 3 during a second time period. The second time period should be two seconds, but the second time period could also be a different length of time. In other embodiments of the present invention, the initial portion and the associated portion can be shown or heard by either the left section 2, the right section 3, or the speaker 9 for the second step and the third step depending on the learning objective and the user's cultural background. The fourth step is to perpetually repeat the first step, the second step, and the third step.

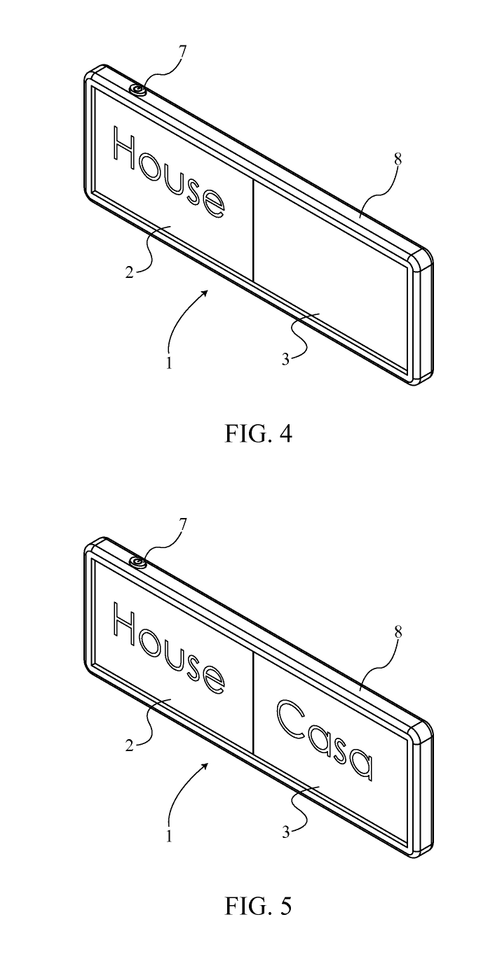

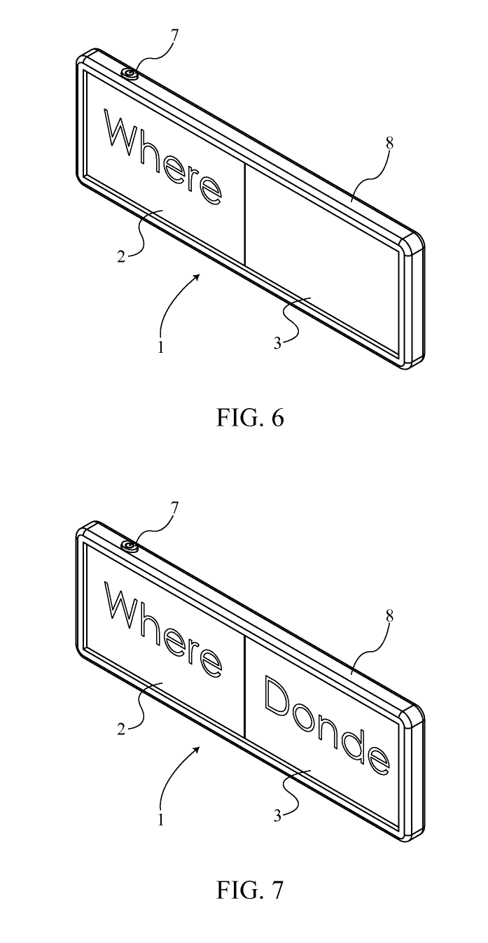

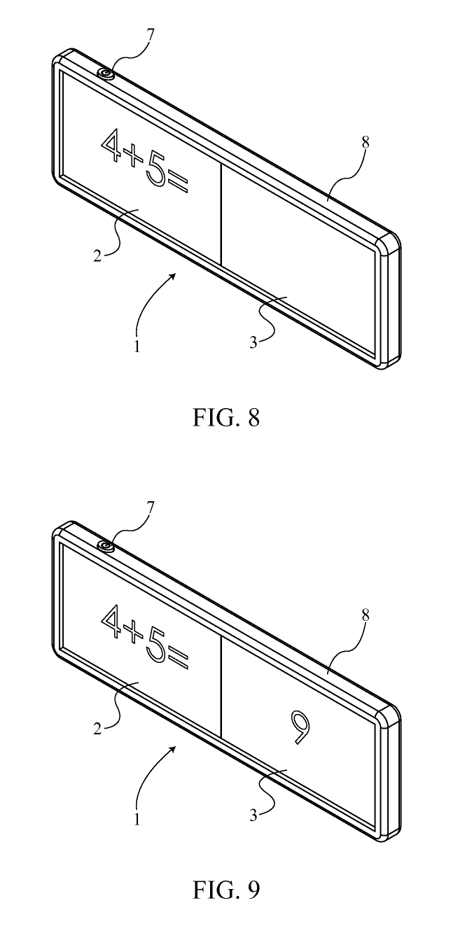

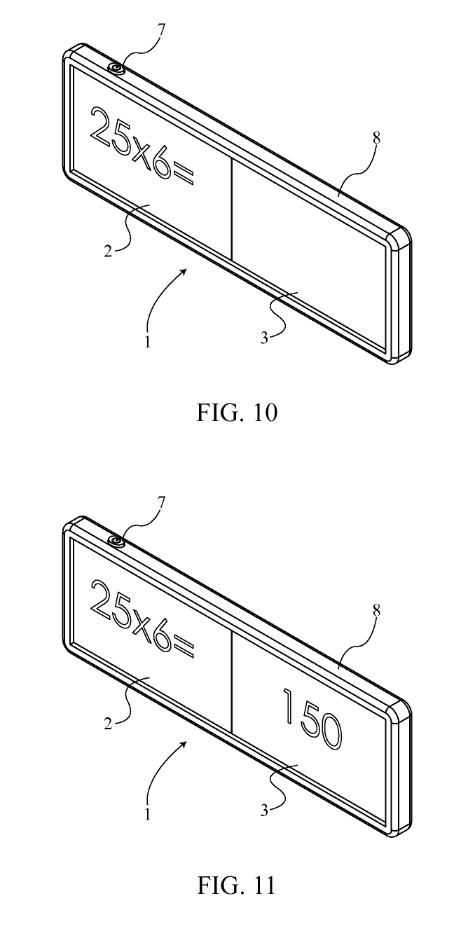

The present invention is capable of teaching a number of different learning objectives. If the user wants to learn a different language and complete a bilingual learning objective, then each teaching point will be a translated word between the two languages, which is shown in FIGS. 4, 5, 6, and 7. The initial portion of a teaching point will be a word in a language known by the user, and the associated portion of the teaching point will be the word in a target language that the user would like to learn. For example, in a restaurant which is frequently occupied by 99% English speaking customers, there is a 99% chance that the workers delivering supplies, preparing meals, busing, and washing the dishes, and cleaning up are Spanish speaking. Both the customers and the workers need to know what each other is saying. If the user wants to learn first grade math and complete a mathematic learning objective, then each teaching point will be an addition or subtraction exercise, which is shown in FIGS. 8 and 9. The initial portion will be the addition or subtraction problem, and the associated portion will be the answer to that addition or subtraction problem. For example, 1st graders are required to recognize 120 frequently sighted words before moving up to 2nd grade and basic math skills such as the plus sign, the minus sign, and the equal sign in the context of an arithmetic problem. Additionally, our over 40% dropout rate clearly highlights the lack of preparation for those children entering elementary school. Thus, the present invention can be used in an area where a young child can learn the alphabet, numbers, and short words. If the user wants to learn third grade math and complete a different mathematic learning objective, then each teaching point will be a multiplication or division exercise, which is shown in FIGS. 10 and 11. The initial portion will be the multiplication or division problem, and the associated portion will be the answer to that multiplication or division problem.

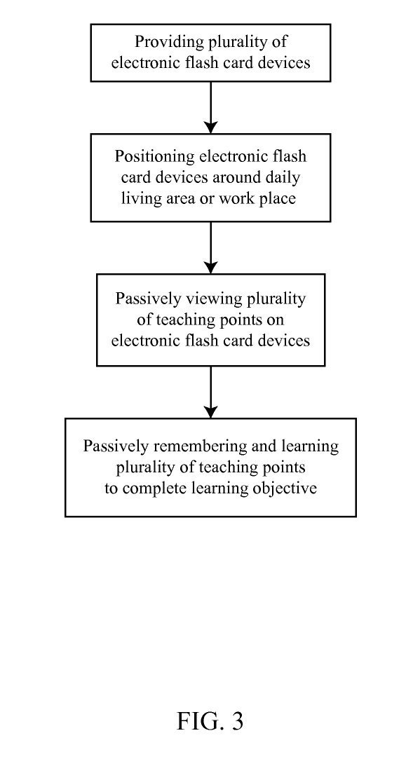

As can be seen in FIG. 3, the user must follow a method to passively complete a learning objective with the present invention. The method begins by gathering a plurality of the electronic flash card devices because the user will have a greater probability of viewing the learning objective on their display panels 1. The method proceeds by placing the electronic flash card devices around the user's daily living area or their work place so that the user can easily view them through their day. The method continues by passively viewing the plurality of teaching points, which are displayed by the electronic flash card devices every day. The method concludes by remembering and learning the plurality of teaching points so that the user completes the learning objective. The proof that someone can passively learn a plurality of teaching points is that humans have been able to recite commercials which they have seen numerous times. Actuarial accountability can be determined by pre-testing a control group prior to installation (hanging on a wall where the control group would frequently pass), and re-testing that group 3 to 6 months later.

Although the invention has been explained in relation to its preferred embodiment, it is to be understood that many other possible modifications and variations can be made without departing from the spirit and scope of the invention as hereinafter claimed.

What is claimed is:

1. An electronic flash card device comprises,
a display panel;
an internal power source;
a central processing unit (CPU);
a data storage device;
an on/off switch;
an enclosure;
a speaker;
said display panel comprises a left section and a right section;
said display panel being framed onto said enclosure;
said internal power source, said CPU, a data storage device, and said speaker being located inside of said enclosure;
said speaker being positioned adjacent to said enclosure;
said on/off switch being positioned on said enclosure;
said internal power source being electrically connected to said CPU, said data storage device, said speaker, said left section, and said right section;
said left section being electronically connected to said CPU;
said right section being electronically connected to said CPU;
said on/off switch being electronically connected to said CPU; and
said speaker being electronically connected to said CPU.

2. A method of displaying a plurality of teaching points at a timed interval by executing computer-executable instructions stored on a non-transitory computer-readable medium, the method comprises the steps of:
providing a display panel, wherein said display panel comprises a left section and a right section;
providing a preloaded database, wherein said preloaded database stores a plurality of teaching points;
providing each of said plurality of teaching points includes an initial portion and an associated portion;
providing a sequential order for said plurality of teaching points;
(1) retrieving a proper teaching point, according to said sequential order of said plurality of teaching points, from said preloaded database;
(2) displaying said initial portion of said proper teaching point on said left portion during a first time period;
(3) displaying both said initial portion of said proper teaching point on said left portion and said associated portion on said right section during a second time period; and
(4) perpetually repeating steps (1), (2), and (3).

3. The method of displaying a plurality of teaching points at a timed interval by executing computer-executable instructions stored on a non-transitory computer-readable medium of claim 1, wherein said first time period is two seconds and said second time period is two seconds.

4. The method of displaying a plurality of teaching points at a timed interval by executing computer-executable instructions stored on a non-transitory computer-readable medium of claim 1, wherein said preloaded database contains said plurality of teaching points relating to a bilingual learning objective.

5. The method of displaying a plurality of teaching points at a timed interval by executing computer-executable instructions stored on a non-transitory computer-readable medium of claim 4, wherein said initial portion is a word in a known language and said associated portion is said word in a target language.

6. The method of displaying a plurality of teaching points at a timed interval by executing computer-executable instructions stored on a non-transitory computer-readable medium of claim 1, wherein said preloaded database contains said plurality of teaching points relating to a mathematic learning objective.

7. The method of displaying a plurality of teaching points at a timed interval by executing computer-executable instructions stored on a non-transitory computer-readable medium of claim 6, wherein said initial portion is an arithmetic problem and said associated portion is an answer to said arithmetic problem.

8. A method of passively learning a plurality of teaching points with a plurality of electronic flash card devices comprises the steps of:
providing a plurality of electronic flash card devices;
positioning said plurality of electronic flash card devices around daily living area and work place;
passively viewing said plurality of teachings points every day, wherein said plurality of teaching points is displayed by said plurality of electronic flash card devices; and
passively remembering and learning said plurality of teaching points in order to complete a learning objective.
